(19) United States
(12) Patent Application Publication
(10) Pub. No.: US 2014/0011993 A1
(43) Pub. Date: Jan. 9, 2014

(54) PROCESS FOR PREPARING SILICA PARTICLES CONTAINING A PHTHALOCYANINE DERIVATIVE BY MICROWAVE IRRADIATION, SAID PARTICLES AND USES THEREOF

(71) Applicants: Aurélien Auger, Le Mans (FR); Julien Jouhannaud, Volgre (FR)

(72) Inventors: Aurélien Auger, Le Mans (FR); Julien Jouhannaud, Volgre (FR)

(73) Assignee: Commissariat A L'Energie Atomique et Aux Energies Alternatives, Paris (FR)

(21) Appl. No.: 13/984,287

(22) PCT Filed: Feb. 15, 2012
(86) PCT No.: PCT/EP12/52586

§ 371 Date: Sep. 13, 2013

(30) Foreign Application Priority Data
Feb. 16, 2011 (FR) 11 51272

(51) Int. Cl. C09B 47/30

(52) U.S. Cl. CPC C09B 47/30
USPC 540/128

(57) ABSTRACT

The present invention relates to a process for preparing a silica particle incorporating at least one phthalocyanine derivative, said particle being prepared from at least one silicone-based derivative of phthalocyanine via a hydrothermal synthesis involving microwaves. The present invention also relates to the silica particles thus prepared and the uses thereof.

### TECHNICAL FIELD

The present invention relates to the field of silica particles and in particular silica nanoparticles which contain silica phthalocyanine type dyes.

The subject of the present invention is in fact a process for the preparation of silica particles incorporating derivatives of phthalocyanine and of naphthalocyanine. It also relates to silica particles incorporating derivatives of phthalocyanine and of naphthalocyanine which can be prepared by this process, and their various uses and applications.

### THE STATE OF THE PRIOR ART

The synthesis and the properties of dyes derived from silicone phthalocyanine or naphthalocyanine complexes which possess axial ligands have been described in the literature by Kenney [1], Joyner [2], and Esposito [3]. Considerable interest has developed over the last few years due to the physical and chemical properties of phthalocyanines. This interest is partly due to their possible applications in various fields such as electrophotography [4], liquid crystals [5], conductive polymers [6], electrochromic displays [7], the photo-electrochemical conversion of energy [8], infrared absorbent agents for transparent thermoplastics and cross-linked polymers [9], and photo-conductivity [10].

Phthalocyanines and other macrocyclic analogues have in effect drawn considerable attention as molecular materials with exceptional electronic and optical properties. These properties are a result of the delocalisation of the electron cloud, and make these products of interest in various fields of research in materials science and most particularly in nanotechnology. Thus phthalocyanines have been successfully incorporated into semiconductor components, electrochromic devices, and information storage systems.

A crucial problem that must be considered in order to incorporate phthalocyanines into technological devices is the control of the spatial arrangement of these macrocycles. This allows the physical and chemical properties of phthalocyanines to be extended and improved at the macromolecular or molecular level. Co-facial superimposition of phthalocyanines must be achieved in order to obtain supramolecular properties. For example, it is possible to increase conductivity along the main axis of the phthalocyanine stacking system through delocalisation of electrons across coplanar macrocycles. Conductivity in phthalocyanine-based systems depends in general terms on the intrinsic properties of highly-specific phthalocyanines. Thus silicone phthalocyanines have been used for the preparation of devices such as field effect transistors. Good conductivity is also achieved in phthalocyanine-based polymers. Of the wide variety of semi-conductiving polymers based on phthalocyanines, the largest group is that of phthalocyanine siloxanes [PcSiO₂]ₙ.

Thus nano-objects and other phthalocyanine siloxane polymers are well known in the prior art. According to the literature these structures are manufactured in a variety of ways. Several methods for the polymerisation of silica phthalocyanine have been validated.

The preparation of phthalocyanine polysiloxanes has been described in the literature. Thus polymers have been synthesised using silicone phthalocyanines as precursors. These compounds are used in the preparation of Langmuir-Blodgett films, which are one-dimensional, highly rigid polymer films [11]. Polymerisation is carried out under very extreme conditions: under vacuum at 350-400° C. over a period of 2 hours. Another polymer synthesis is carried out using the same silicone phthalocyanine precursor in dimethyl sulphoxide at 135° C. over 24 hours [12]. More recently a new, more appropriate, protocol has been reported for preparing oligomers with 3 to 4 monomer units (silicone phthalocyanine) [13], where in said protocol includes the condensation of monomers in the presence of quinoline, followed by silylation with tert-butyldimethylsilyl chloride (TBDMSCI).

Another approach has been developed in order to obtain a polymer which is cross-linked axially to the plane of the aromatic macrocycle of the phthalocyanine. Thus, axial functionalisation has resulted in a silicone phthalocyanine which is axially conjugated with a poly(polysebacic acid anhydride). The product thus obtained was then used to form hydrophilic nanoparticles via a microphase inversion method [14].

It should be emphasised that in general these polymers exhibit high electrical conductivities. These materials are also, however, insoluble both in water and in common organic solvents, which makes their industrial-scale preparation difficult. In effect, the organic character of the aromatic macromolecules of the phthalocyanine type makes them highly insoluble. The degree of insolubility is more pronounced when using naphthalocyanines or anthracene analogues. This phenomenon is in part due to the aggregates formed by π-π interactions. It is therefore sometimes necessary to substitute the aromatic macrocycle at peripheral and/or non-peripheral positions in order to confer good solubility in organic solvents to this group of dyes. Unfortunately, this functionalisation process can result in changes to intrinsic properties. Thus in certain cases it is preferable to keep the aromatic network non-substituted.

The encapsulation of silicone phthalocyanines has also been the subject of several studies. Given the well-known pronounced hydrophobic properties of phthalocyanine based materials, it is therefore very difficult to encapsulate them in nano-objects made of silica using a conventional wet process.

Thus a silicone phthalocyanine bis-oleate derivative has been introduced into lipoprotein nanoparticles in order to use these products as lipoprotein-based nanoplatforms. These compounds are subsequently used as multifunctional diagnostic and therapeutic devices [15]. A patent application also describes the encapsulation of copper phthalocyanine crystals (no mention of silicone being present) [16]. The study of nanoparticles prepared in this way for inks containing dispersions, for colour filters and for composition of photosensitive dyed resins has also been reported [17].

Another study describes the formation of cadmium selenide nanoparticles (CdSe) conjugated with silicone phthalocyanines. The surface of CdSe nanoparticles is thus functionalized by condensation of the active group (amine group) located at axial position of the silicone phthalocyanine macrocycle and linked to it by an alkyl group [18]. A similar study published in 2006 describes the introduction of copper phthalocyanine tetrasulphfonate on the surface of silica nanoparticles modified by functionalization with amine groups [19].

International patent application WO 2008/138727 reports the preparation of silica nanoparticles functionalized by copper phthalocyanine. The siloxane function carried by the copper phthalocyanine and which is necessary for the formation of silica nanoparticles lies a peripheral position and requires a functionalization step of the copper phthalocyanine [20].

In general terms, the preparation of silica nanoparticles can be achieved by sol-gel processes such as the Ströber process or a process using reverse micro-emulsion. Another technique which is much faster than the two aforementioned processes has also been described. This latter involves irradiation using micro-waves. Thus spherical, colloidal mono-dispersed silica nanoparticles have been synthesised by the hydrolysis and condensation of tetraethoxysilane (TEOS) in a methanol/water/ammonia mixture using a hydrothermal synthesis process involving continuous irradiation by microwaves [21].

Similarly, the effect of the type of precursors (TEOS or tetrachlorosilane (SiCl₄)) and of the feed-rate thereof on the size of silica particles and their distribution has been studied [22]. In this article the silica particles are synthesised by a process which involves a micro-wave plasma. From the obtained results it emerges that TEOS allows larger spherical nanoparticles to be obtained than those obtained from SiCl₄.

Dispersions of spherical nanoparticles have also been obtained by microwave irradiation of a dispersion, in water, of droplets of zinc phthalocyanine dissolved in acetone. The spherical geometry of these nanoparticles has been verified by transmission electron microscopy [23].

Considering the interest of phthalocyanine-based materials, there is a real need for a simple, practical and fast process which does not require several steps or prior functionalization of phthalocyanines and which can be applied on an industrial scale to the preparation of phthalocyanine-based materials such as silica particles.

### PRESENTATION OF THE INVENTION

The present invention enables the technical disadvantages and problems of the above-listed techniques to be remedied.

Indeed, it proposes a process for the preparation of particulate silica-based materials, and notably nanoparticle materials which incorporate phthalocyanine derivatives, said process is capable of being applied at an industrial scale, does not require cumbersome processes or steps and uses readily available, non-hazardous and low toxicity products.

The work by the inventors has revealed that the use of silicone phthalocyanine derivatives as silica precursors allows silica particles to be manufactured, such as silica nanoparticles, which incorporate phthalocyanine derivatives. The availability of axial ligands such as hydroxyls or chlorides, combined with the presence of the silica atom introduced into the phthalocyanine macrocycle cavity allows the latter to be used as a precursor needed for the proper synthesis of silica nanoparticles, using the hydrothermal synthesis procedure involving microwaves, also referred to as the “synthesis by microwave irradiation procedure”.

Indeed, the phthalocyanine has a central cavity which allows a large number of atoms to be incorporated, including silicon. Since a silicon atom is tetravalent and requires two bonds for it to be incorporated into the cavity and the plane of phthalocyanine aromatic macrocycle, there are two bonds still available. These two bonds are axial to the plane defined by the silicon atom and the phthalocyanine, and are generally terminated with functions of the hydroxyl and chloride types. Since these are reactive functions, they act as reactants in the synthesis of silica nanoparticles.

The inventors have used the hydrothermal synthesis route which uses microwaves for preparing silica particles from such silicone-based derivatives of phthalocyanine.

Conventional sol-gel processes such as the Stöber type of method and the method using a reverse micellar route allow silica particles to be prepared quite quickly. These processes are dependent on the rate of hydrolysis of silica precursors and the reaction usually takes between a few minutes and several hours. It is known that the hydrothermal synthesis process involving microwaves is much faster, with the reaction completed in a few seconds [21]. This rapidity, due to acceleration of the hydrolysis and crystallisation kinetics, means that the heating time (i.e. irradiation period) is reduced, resulting in energy savings.

In addition to this known advantage, the inventors have observed that the hydrothermal synthesis process involving microwaves, when used with silicone-based derivatives of phthalocyanine, produces an agglomerate-free nanoscopic material. Furthermore, the material produced, which is of a nanoparticle type based on an aromatic and hydrophobic macrocycle (phthalocyanine), is stable in water, thus avoiding the problem of dispersion of the nanoobjects formed.

Furthermore, this process produces little or even no reaction side-products or by-products. It is characterised by the introduction of substances required for the synthesis and the total consumption thereof. The solvent is removed by evaporation and the base used to hydrolyse the silane-based compounds can be broken down into volatile products.

Finally the hydrothermal synthesis process involving microwaves used with silicone-based derivatives of phthalocyanine allows particles of silica to be obtained which have remarkable properties (nano-plate form, crystalline, conductive and pure) which will be described in more detail later.

Thus the present invention relates to a process for preparing a silica particle which incorporates at least one phthalocyanine derivative, said particle being prepared from at least one silicone-based derivative of phthalocyanine via hydrothermal synthesis involving microwaves.

In the context of the present invention, the expressions “silicone-based phthalocyanine derivative” and “silane-based phthalocyanine derivative” are equivalent and may be used interchangeably.

The term “silicone-based phthalocyanine derivative” refers to compounds of the formula (I):

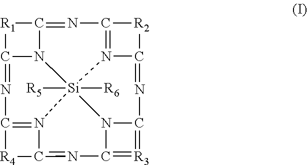

in which:
R₁, R₂, R₃ and R₄, which are identical or different, represent an arylene group which may be substituted and
R₅ and R₆, which are identical or different, are selected from the group consisting of —Cl, —F, —OH and —OR′ where R′ represents a linear or branched alkyl of from 1 to 12 carbon atoms and notably from 1 to 6 carbon atoms, which may optionally be substituted, or a group —Si(R″)₃ where each R″ independently represents a linear, branched or cyclic alkyl of from 1 to 12 carbon atoms and notably from 1 to 6 carbon atoms, which may optionally be substituted.

The term “optionally substituted” means, in the context of alkyl groups of formula (I), substituted by a halogen, an amine group, a diamine group, an amide group, an acyl group, a vinyl group, an hydroxyl group, an epoxy group, a phosphonate group, a sulphonic acid group, an isocyanate group, a carboxyl group, a thiol (or mercapto) group, a glycidoxy group or an acryloxy group and in particular a methacryloxy group. Advantageously, R′ represents a methyl or an ethyl group.

The term “arylene group” in the context of the present invention means an aromatic or heteroaromatic carbon-containing structure, optionally mono- or poly-substituted, made up of one or more aromatic or hetero-aromatic cycles which each contain 3 to 8 atoms, where the heteroatom or heteroatoms may be N, O, P or S.

The term “optionally substituted” means an arylene group which may be mono- or poly-substituted by a group selected from the group consisting of a carboxylate; an aldehyde; an ester; an ether; a hydroxyl; a halogen; an aryl such as phenyl, benzyl or a naphthyl; a linear or branched alkyl of from 1 to 12 carbon atoms and notably from 1 to 6 carbon atoms, optionally substituted, such as methyl, ethyl, propyl or hydroxypropyl; an amine; an amide; a sulphonyl; a sulphoxide and a thiol.

Advantageously, the R₁, R₂, R₃ and R₄ groups are identical or different, each representing a phenylene, a naphthylene or an anthracene. More specifically, the R₁, R₂, R₃ and R₄ groups are identical and represent a phenylene, a naphthylene or an anthracene.

In particular, the silicone-based derivative of phthalocyanine used in the context of the present invention is a compound of formula (II):

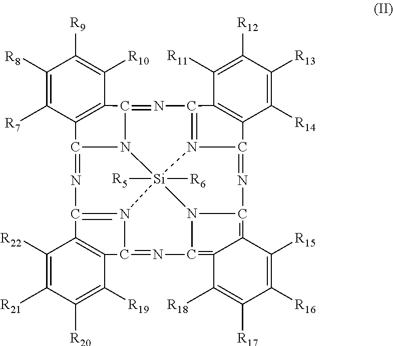

in which:
the groups R₇ to R₂₂, which are identical or different, are chosen from the group consisting of a hydrogen; a carboxylate; an aldehyde; a ketone; an ester; an ether; a hydroxyl; a halogen; an aryl such as phenyl, benzyl or naphthyl; a linear or branched alkyl, of from 1 to 12 carbon atoms and notably from 1 to 6 carbon atoms, optionally substituted, such as methyl, ethyl, propyl or hydroxypropyl; an amine; an amide; a sulphonyl; a sulphoxide and a thiol;
the groups R₅ and R₆ are as previously defined.

A preferred compound of formula (II) in the context of the present invention is the compound in which the groups R₇ to R₂₂ represent a hydrogen and the groups R₅ and R₆ are as previously defined.

Alternatively, the silicone-based derivative of phthalocyanine used in the context of the present invention is a compound of formula (III) of the naphthalocyanine type:

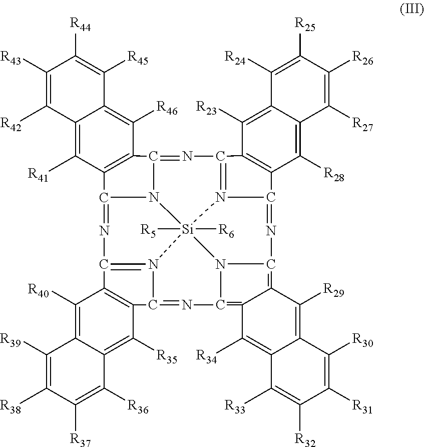

in which:
the groups R₂₃ to R₄₆, which are identical or different, are chosen from the group consisting of a hydrogen; a carboxylate; an aldehyde; a ketone; an ester; an ether; an hydroxyl; a halogen; an aryl such as phenyl, benzyl or naphthyl; a linear or branched alkyl, of from 1 to 12 carbon atoms and notably from 1 to 6 carbon atoms, optionally substituted, such as methyl, ethyl, propyl or hydroxypropyl; an amine; an amide; a sulphonyl; a sulphoxide and a thiol;
the groups R₅ and R₆ are as previously defined.

A preferred compound of formula (III) in the context of the present invention is the compound in which the groups R₂₃ to R₄₆ represent a hydrogen and the groups R₅ and R₆ are as previously defined.

In formulae (I), (II) and (III), the bonds in dotted lines represent coordinate bonds or dative bonds.

Advantageously the groups R₅ and R₆ in the compounds of formula (I), (II) or (III) are identical and are selected from the group consisting of —Cl, —F, —OH and —OR′ where R′ represents a linear or branched alkyl of from 1 to 12 carbon atoms and notably from 1 to 6 carbon atoms, optionally substituted and notably selected from the group consisting of —Cl, —F, —OH, —OCH₃ and —OC₂H₅. More particularly, the groups R₅ and R₆ in the compounds of formula (I), (II) or (III) are identical and represent —OH or —Cl.

The compounds of formula (II) and (III) that are given most particular use in the context of the present invention are a phthalocyaninatodichlorosilane complex, a phthalocyaninadihydroxysilane complex, a naphthalocyaninatodichlorosilane complex and a naphthalocyaninatodihydroxysilane complex. These complexes may be represented with R representing —OH or —Cl in the following manner:

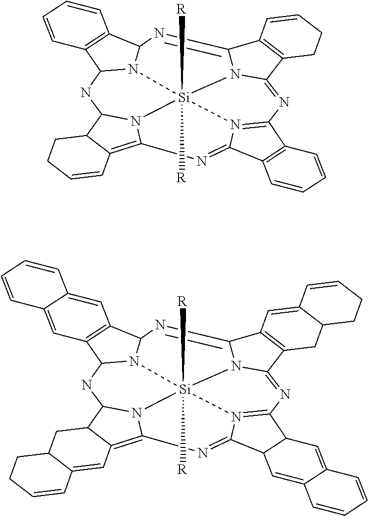

Alternatively, the groups R₅ and R₆, in the compounds of formula (I), (I) or (Ill) correspond to formula —OR′ where R′ represents a group —Si(R″)₃ where each R″ independently represents a linear, branched or cyclic alkyl of from 1 to 12 carbon atoms and notably from 1 to 6 carbon atoms, optionally substituted. Advantageously the R″ groups, which are identical or different, are selected from methyl, ethyl, propyl, cyclopropyl, butyl, cyclobutyl, heptyl, cycloheptyl, hexyl and cyclohexyl. More particularly the groups R₅ and R₆ are identical.

Thus another compound of formula (III) which is quite specifically used in the context of the present invention is a compound in which the groups R₂₃ to R₄₆ represent a hydrogen and the groups R₅ and R₆ are identical and represent a group —O—Si [CH₂(CH₂)₄CH₃]₃.

The process according to the invention includes, more particularly, the following successive steps:

a) preparing a first solution (Sₐ) containing at least one silicone-based derivative of phthalocyanine and optionally at least one silane-based compound;

b) mixing the solution (Sₐ) obtained in step (a) with a second aqueous solution (S′) which contains at least one compound allowing hydrolysis of a silane-based compound,

c) exposing the solution (S_{b}) obtained in step (b) to microwave irradiation,

d) recovering the silica particles incorporating at least one silicone-based derivative of phthalocyanine, obtained during step (c).

Step (a) of the process according to the invention therefore involves preparing a solution (Sₐ) containing at least one silicone-based derivative of phthalocyanine, notably as defined previously. Any technique which allows such a solution to be prepared can be used in the context of the present invention.

The solution (Sₐ) is obtained, during step (a) of the process in accordance with the invention, by mixing together:
at least one silicone-based derivative of phthalocyanine,
at least one water-miscible organic solvent and
optionally at least one silane-based compound.

It is, of course, to be understood that the possible silane-based compound is different from the silicone-based derivative of phthalocyanine.

Advantageously the silicone-based derivative of phthalocyanine and the optional silane-based compound are added, one after the other, to the water-miscible organic solvent and in the following order; silicone-based phthalocyanine derivative then the optional silane-based compound.

In an alternative application of the invention, only the silicone-based derivative of phthalocyanine is introduced into the solution (Sₐ), to the exclusion of any other silane-based compound.

The term “water-miscible organic solvent” means, in the context of the present invention, an organic solvent which forms a homogeneous and stable mixture when in the presence of water.

The organic solvent in the solution (Sₐ) is a polar solvent, i.e. a solvent which possesses a non-zero dipole moment and which is, advantageously, selected from amongst hydroxylated solvents such as methanol, ethanol, iso-propanol and propanol; liquid glycols of low molecular weight such as ethylene glycol; dimethyl sulphoxide (DMSO); dimethyl formamide; dioxane; acetonitrile; acetone; acetic acid; tetrahydrofuran (THF) and mixtures thereof. More particularly, the organic solvent in the solution (Sₐ) is selected from methanol, ethanol and tetrahydrofuran (THF).

The silicone-based derivative(s) of phthalocyanine can be used, during step (a) of the process according to the invention, in solid form, in liquid form or in solution in a water-miscible organic solvent. When several different silicone-based derivatives of phthalocyanine are used, they may be mixed in at the same time or added one after another or in groups.

When the silicone-based derivative(s) is (are) used in solution in a water-miscible organic solvent, the latter may be identical to or different from the water-miscible organic solvent in the solution (Sₐ). Advantageously, the water-miscible organic solvent used to dissolve the silicone-based derivative(s) of phthalocyanine is identical to the water-miscible organic solvent in the solution (Sₐ).

Alternatively the silicone-based derivative(s) of phthalocyanine is (are) in solid form and is (are) dissolved in the solvent of solution (Sₐ).

Mixing in step (a) is carried out whilst stirring using a stirrer, a magnetic bar, an ultrasonic bath or homogenizer, and may be carried out at a temperature of between 10 and 40° C., advantageously between 15 and 30° C. and, more particularly at ambient temperature (i.e. 23° C.±5° C.).

In the solution (Sₐ), the silicone-based derivative of phthalocyanine or the mixture of silicone-based derivatives of phthalocyanine exhibits a molarity of between 100 μM and 400 mM, notably between 500 μM and 300 mM and, in particular, between 1 mM and 200 mM. The water-miscible organic solvent or the mixture of water-miscible organic solvents (water-miscible organic solvents in which the silicone-based derivative(s) of phthalocyanine is (are) in solution and/or other water miscible organic solvent in the solution (Sₐ)) is present, in the solution (Sₐ), in a proportion of between 80 and 100%, notably between 90 and 100% and, in particular, between 95 and 100% by volume relative to the total volume of said solution.

The presence in the solution (Sₐ) of a silane-based compound and/or several silane-based compounds is optional. The particular example described below in addition includes no additional silane-based compound. When a silane-based compound or several silane-based compounds, identical or different, are present it (they) is (are) incorporated in the solution (Sₐ) to give, just like the silicone-based derivative(s) of phthalocyanine and via the synthesis using microwave irradiation, the silica of the silica particles according to the invention.

The silane-based compound(s) may be introduced into the solution (Sₐ) in solid form, in liquid form or in solution in a water-miscible organic solvent. When several different silane-based compounds are used, they may be mixed in at the same time or be added one after another or in groups.

When the silane-based compound(s) is (are) used in solution in a water-miscible organic solvent, the latter may be identical to or different from the water-miscible organic solvent in the solution (Sₐ). It may also be identical to or different from the water-miscible organic solvent used to dissolve the silicone-based derivative(s) of phthalocyanine.

Advantageously, the silane-based compound(s) is (are) introduced into the solution (Sₐ) in liquid form. In the solution (Sₐ), the silane-based compound(s) is(are) present in a proportion between 0.1 and 40%, notably between 1 and 30% and in particular between 5 and 25% by volume relative to the total volume of said solution.

In the solution (Sₐ), the silane-based compound(s) exhibit(s) a molarity of between 100 μM and 400 mM, notably between 500 μM and 300 mM and, in particular, between 1 mM and 200 mM.

Advantageously, said silane-based compound(s) is (are) of general formula SiRₐR_{b}R_{c}R_{d} in which Rₐ, R_{b}, R_{c} and R_{d} are, independently of each other, selected from the group consisting of a hydrogen; a halogen; an amine group; a diamine group; an amide group; an acyl group; a vinyl group; an hydroxyl group; an epoxy group; a phosphonate group; a sulphonic acid group; an isocyanate group; a carboxyl group; a thiol (or mercapto) group; a glycidoxy group; an acryloxy group such as a methacryloxy group; a linear or branched alkyl group, optionally substituted, of 1 to 12 carbon atoms, notably from 1 to 6 carbon atoms; a linear or branched aryl group, optionally substituted, of 4 to 15 carbon atoms, notably 4 to 10 carbon atoms; an alkoxyl group of formula —OR, where Rₑ represents an alkyl group as defined previously, and salts thereof.

The term “optionally substituted” means, in the context of alkyl and aryl groups of the silane-based compounds, substituted by a halogen, an amine group, a diamine group, an amide group, an acyl group, a vinyl group, a hydroxyl group, an epoxy group, a phosphonate group, a sulphonic acid group, an isocyanate group, a carboxyl group, a thiol (or mercapto) group, a glycidoxy group or an acryloxy group and notably a methacryloxy group.

In particular, said silane-based compound(s) is (are) an (or some) alkylsilane(s) and/or an (or some) alkoxysilane(s). Also, the silane-based compound is, more particularly, selected from the group consisting of dimethylsilane (DMSi), phenyltriethoxysilane (PTES), tetraethoxysilane (TEOS), tetramethoxysilane (TEMOS), n-octyltriethoxysilane, n-octadecyltriethoxysilane, dimethyldimethoxysilane (DMDMOS), (3-mercaptopropyl)trimethoxysilane, (3-mercaptopropyl)triethoxysilane, (mercapto)-triethoxysilane, (3-aminopropyl)triethoxysilane, 3-(2-aminoethylamino)propyltrimethoxysilane, 3-[bis(2-hydroxyethyl)amino]propyltriethoxysilane, hexadecyltrimethoxysilane, phenyltrimethoxysilane, N-[3-(trimethoxysilyl)propyl]-1,2-ethanediamine and acetoxyethyltriethoxysilane, 2-hydroxy-4-(3-triethoxysilylpropoxy)diphenylketone, methyltriethoxysilane, vinyltrimethoxysilane, (3-glycidoxypropyl)trimethoxysilane, (benzoyloxypropyl)trimethoxysilane, sodium 3-trihydroxysilylpropylmethylphosphonate, (3-trihydroxysilyl)-1-propanesulphonic acid, (diethylphosphonatoethyl)triethoxysilane, and mixtures thereof. More particularly, the silane-based compound is tetramethoxysilane (TEOS, Si(OC₂H₅)₄).

For functionalization of the surface of the silica plates obtained according to the invention, the silane-based compound used may be a mixture containing less than 20% and notably from 5 to 15% of a pre-functionalized silane, relative to the total quantity of silane-based compounds. As an example, a mixture containing TEOS and from 5 to 15% of mercaptotriethoxysilane may be utilised for the preparation of particles of silica according to the invention and functionalized by thiol groups.

The step (b) of the process according to the invention allows hydrolysis of the silicone-based phthalocyanine derivative(s) and optionally a (or some) silane-based compound(s) contained in the solution (Sₐ), by mixing the latter with an aqueous solution of a compound that allows this hydrolysis to take place.

Step (b) involves, more particularly, mixing the solution (Sₐ) with a solution (S′) obtained by dissolving at least one compound allowing hydrolysis of the silane-based compound in the water.

The solution (S′) may be prepared before, after or simultaneously with step (a) of the process according to the present invention.

The water used in the solution (S′) may be de-ionised water, optionally acidified or basic, distilled water, optionally acidified or basic, or a mixture thereof. Advantageously, the water used in the solution (S′) is ionised water, with the latter being neither acidified nor basic.

Water is present in the solution (S′), in a proportion of between 80 and 100%, notably between 90 and 100% and in particular, between 95 and 100% by volume relative to the total volume of said solution.

It should be noted that the term “compound allowing the hydrolysis of a silane-based compound” means a base-type compound, which not only allows the hydrolysis of a silane-based compound, notably as previously defined, but also the hydrolysis of a silicone-based derivative of phthalocyanine.

The compound which allows the hydrolysis of a silane-based compound is advantageously selected from the group consisting of urea, thiourea, ammonia, an amine such as trimethylamine or triethylamine and mixture thereof. The compound which allows the hydrolysis of a silane-based compound which is used in the context of the present invention is, more specifically, urea. Indeed, urea exhibits the advantageous property of degrading into volatile products (CO₂ and NH₄OH) during implementation of the process according to the invention.

The compound which allows the hydrolysis of a silane-based compound exhibits a molarity of between 100 μM and 400 mM, notably between 500 μM and 300 mM and, in particular, between 1 mM and 200 mM in the solution (S′).

Step (b) of the process according to the present invention therefore involves adding the solution (S′) to the solution (Sₐ) prepared during step (a). This addition is made rapidly and, in particular, the solution (Sₐ) is injected into the solution (S′).

The ratio [volume of Solution (Sₐ)]/[volume of Solution (S′)] is advantageously between 1/2000 and 1/20, notably between 1/1600 and 1/50 and in particular between 1/1200 and 1/80 and most particularly between 1/200 and 1/80.

Step (b) may be carried out under stirring by using a stirrer, a magnetic bar, an ultrasonic bath or a homogenizer. This stirring is advantageously carried out once the mixing of solution (Sa) and solution (S′) has been carried out. Typically the stirring of the solution carried out during step (b) of the process according to the invention is vigorous stirring. In particular, the solution (S_{b}) obtained undergoes stirring at between 50 and 1000 rpm and notably between 100 and 800 rpm.

Step (b) may be carried out at a temperature of between 10 and 40° C., advantageously between 15 and 30° C. and, more specifically, at ambient temperature (i.e. 23° C.±5° C.) for a period of between 30 sec and 10 min and, notably, between 1 min and 5 min. The duration of the stirring phase during step (b) is advantageously between 15 sec and 6 min and notably between 30 sec and 3 min.

The aim of step (c) of the process according to the invention is to heat the solution (S_{b}) and to force the water-miscible organic solvent that it contains to evaporate rapidly, whereby the compounds formed from the hydrolysis of the silicone-based derivative(s) of phthalocyanine and possibly of the silane-based compound(s) present in the solution (S_{b}) condense to form particles of silica.

The objective of step (c) is achieved by subjecting the solution (S_{b}) to microwave irradiation. Advantageously, the power used during this irradiation is between 200 W and 1000 W, notably between 450 W and 900 W and, in particular, between 500 W and 800 W. The irradiation by microwaves may be carried out using a microwave oven such as a Sharp Compact R-230A or a microwave generator such as those described in [21] and [22] or a Labo-star Stereomode from Synerwave.

Step (c) may be carried out over a period between 5 sec and 5 min, notably between 10 sec and 3 min, and in particular between 20 sec and 1 min. More specifically, irradiation of 30 sec or of 45 sec may be used.

Any technique which allows silica particles which incorporate at least one phthalocyanine derivative obtained by condensation during step (c) to be recovered may be used during step (d) of the process according to the invention. Advantageously, this step (d) uses one or more identical or different steps, selected from centrifugation, sedimentation and washing steps.

The washing step(s) is(are) carried out in a polar solvent such as water, deionised water, distilled water, acidified or basic; hydroxylated solvents such as methanol, ethanol, and iso-propanol; liquid glycols of low molecular weight such as ethylene glycol; dimethyl sulphoxide (DMSO); acetonitrile; acetone; tetrahydrofuran (THF) and mixtures thereof, hereafter referred to as “washing solvent”. Advantageously the polar solvent(s) used during the washing steps are selected from the group consisting of water, deionised water, distilled water, acidified or basic water, a hydroxylated solvent and mixtures thereof. When the recovery step uses several washings, a given polar solvent is used for several or even for all the washings or several different polar solvents are used at each washing.

As regards a (or several) centrifugation step(s), it (they) may be carried out by centrifuging the particles of silica, notably in a washing solvent at ambient temperature, at a speed between 4000 and 10000 rpm and, in particular, of the order of 8000 rpm (i.e. 8000±500 rpm) for a period of between 1 min and 2 h, notably between 2 min and 1 h, in particular between 3 min and 30 min and, most particularly for 5 min.

Step (d) of the present invention advantageously involves 2 successive washings, separated by sedimentation by centrifugation. More particularly, the 1^{st} wash is carried out with a hydroxylated solvent, notably with ethanol, and the 2^{nd} washing with water.

The process according to the present invention may include, following step (d), an additional step which involves purifying the particles of silica obtained, with this step hereafter being referred to as “step (e)”.

Step (e) advantageously involves placing the particles of silica recovered after step (d) of the process according to the invention in contact with a very large volume of water. The expression “very large volume” means a volume greater by a factor of 50, notably by a factor of 500 and in particular by a factor of 1000, than the volume of the silica particles recovered after step (d) of the process according to the invention. Step (e) may be a dialysis step, where the silica particles are separated from the volume by a cellulose membrane, of the Zellu Trans® type (Roth marketed by). Alternatively, instead of the dialysis step an ultra-filtration step through a polyethersulphone membrane might be envisaged.

Furthermore, step (e) may be carried out under stirring by using a stirrer, a magnetic bar, an ultrasonic bath or an homogenizer, at a temperature between 0 and 30° C., advantageously between 2 and 20° C. and, more particularly, at a cold temperature (i.e. 6° C.±2° C.) for a period of between 30 h and 15 d, notably between 3 d and 10 d and, in particular, for 1 week.

The present invention also relates to the solution (S_{b}) which can be used in the context of the process according to the invention. This solution comprises:
one or more water-miscible organic solvent(s), notably as defined previously,
water, notably as defined previously,
one or more silicone-based derivative(s) of phthalocyanine, notably as defined previously,
one or more compound(s) allowing the hydrolysis of a silane-based compound, notably as defined previously, and
optionally one or more silane-based compound(s), notably as defined previously.

Advantageously, the solution (S_{b}) which is the subject of the present invention includes:
one or more water-miscible solvent(s), notably as defined previously, in a quantity of between 0.01 and 10% and notably between 0.1 and 5% by volume relative to the total volume of said solution,
water, notably as defined previously, in a quantity between 90 and 99.99% and notably between 95 and 99.9% by volume relative to the total volume of said solution,
one or more silicone-based derivative(s) of phthalocyanine, notably as defined previously, in a quantity of between 500 nM and 4 mM, notably between 1 μM and 3 mM and, in particular, between 10 μM and 2 mM,
one or more compound(s) allowing the hydrolysis of a silane-based compound, notably as defined previously, in a quantity of between 100 μM and 400 mM, notably between 500 μM and 300 mM and in particular between 1 mM and 200 mM, and
optionally one or several silane-based compound(s), notably as defined previously, in a quantity of between 500 nM and 4 mM, notably between 1 μM and 3 mM and in particular, between 10 μM and 2 mM.

Yet more specifically the solution (S_{b}) which is the subject of the present invention includes:
THF in a quantity of the order of 1% (i.e. 1%±0.2%) by volume relative to the total volume of said solution,
deionised water in a quantity of the order of 99% (i.e. 99%±0.2%) by volume relative to the total volume of said solution,
one or more silicone-based derivative(s) of phthalocyanine in a quantity of the order of 1.60 mM (i.e. 1.60 mM±0.20 mM),
urea in a quantity of the order of 160 mM (i.e. 160 mM±20 mM).

Furthermore the present invention relates to a silica particle which can be prepared by the process of the present invention. This particle is a silica particle which includes at least one derivative of phthalocyanine, as defined previously. It is distinguished from silica particles in the prior art by the two covalent bonds which link the Si atom to the phthalocyanine derivative, where the phthalocyanine derivative is not a group which functionalizes the silica particle.

Furthermore, and remarkably, the particles of silica obtained according to the process of the invention are distinguished from the spherical particles obtained in the prior art by microwave irradiation (see [21], [22] and [23]) and occur in the form of plates and notably in the form of nanoplates.

The term “nanoplate” in the context of the present invention, refers to a rectangular parallelepiped, at least two of the characteristic dimensions of which are less than or equal to 100 nm. Advantageously a nanoplate in the context of this invention possesses:
a length greater than 100 nm and notably between 100 and 500 nm;
a thickness between 2 and 20 nm and notably between 5 and 10 nm; and
a width between 20 and 80 nm and notably between 40 and 60 nm.

FIG. 1 represents a nanoplate that can be obtained by the process of in the invention.

In the context of the present invention, the terms “silica particle”, “silica nanoparticle”, “silica nanoplate” may be used in an equivalent manner to define the product prepared by the implementation of the process according to the invention.

The silica particles obtained by the process according to the present invention occur in the form of a material which is crystalline and conductive. The crystalline character of these particles and notably of these nanoplates further distinguish them from silica particles of the prior art. Indeed, the silica is generally amorphous when produced by a sol-gel route. Furthermore, the crystallinity of the silica particles according to the invention allows their purity to be controlled, unlike the amorphous silica produced by a sol-gel route. In the context of the preparation process according to the invention, no impurity is introduced into the material. This crystallisation process therefore constitutes, in effect, a purification process.

As regards the conductive character of the silica particles obtained by the process according to the invention, this is closely associated with the conservation of the absorption phenomenon associated with the aromatic macrocycle of the phthalocyanine derivatives, which involves the transfer of electrons and therefore electron delocalisation, making electronic conductivity possible.

The particles of silica according to the invention may optionally be functionaliéed and/or optionally porous.

Finally, the present invention relates to the use of a silica particle according to the invention in fields selected from the group consisting of catalysis, printing, paints, filtration, polymerisation, heat-exchange, thermal stability, materials chemistry, hydrocarbon refining, the production of hydrogen, absorbents, the food industry, the transport of active agents, biomolecules, pharmaceutical products, heat insulation coverings, bio-electronic compounds and electronic, optical, semi-conductor and sensor devices.

Other characteristics and advantages of this invention will become clear to those skilled in the art after reading the non-restrictive examples below, given for illustrative purposes, with reference to the appended figure.

### BRIEF DESCRIPTION OF THE DRAWINGS

FIG. 1 is a schematic representation of a nanoplate that can be obtained by the process according to the present invention.

FIG. 2 shows a view obtained by transmission electron microscopy (TEM) of silica nanoparticles prepared by the process according to the invention with microwave irradiation at 560 W for 30 sec.

FIG. 3 shows a view obtained by transmission electron microscopy (TEM) of silica nanoparticles prepared by the process according to the invention with microwave irradiation at 750 W for 45 sec.

FIG. 4 shows the spectrum obtained during the elemental analysis using EDSX (“energy dispersive spectroscopy of X-rays”) of a nanoparticle which includes a phthalocyanine derivative prepared according to the process in the invention.

FIG. 5 shows the absorption spectra of the phthalocyanine derivatives in nanoparticles prepared according to the process of the invention with microwave irradiation at 560 W for 30 sec, at 560 W for 45 sec, at 750 W for 30 sec and at 750 W for 45 sec.

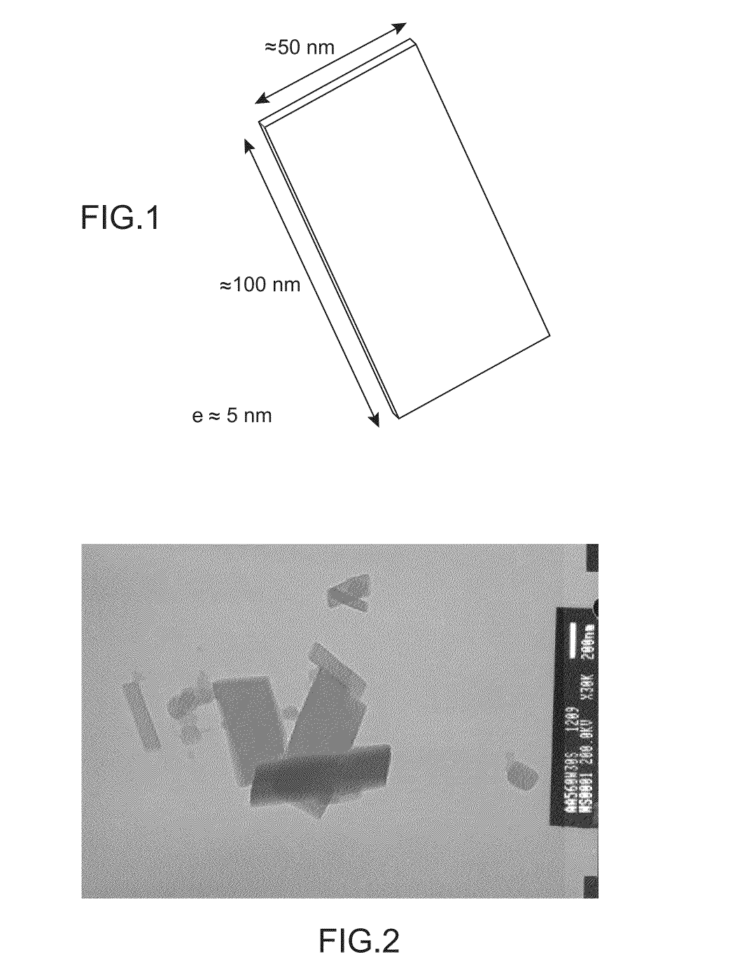

### DETAILED DESCRIPTION OF SPECIFIC EMBODIMENTS

I. Process for the Preparation of Silica Nanoparticles According to the Invention.

A 1 g/l, that is 0.166 M, solution of silica precursor (silicone-based derivative of phthalocyanine): 2,3-naphthalocyaninato-bis(trihexylsiloxy)silane (or “silicon 2,3-naphtalocyanine bis(trihexylsilyloxide”) is prepared in THF.

This solution (200 μl) is injected into 20 mL of deionised water with 1% by mass of urea (that is a solution of 0.166 M urea in deionised water) and the solution obtained is stirred vigorously (100 rpm; 1 min), then irradiated (Labo-star Stereomode from Synerwave) immediately for different times (30 sec and 45 sec) and powers (560 W and 750 W). Thus samples were irradiated for 30 sec at 560 W, for 45 sec at 560 W, for 30 sec at 750 W and for 45 sec at 750 W (that is, four irradiation protocols).

After the washing step (ethanol and water) and a centrifugal sedimentation step (8000 rpm; 5 min), purification of the nanoparticles obtained is carried out by dialysis in water (1 L) with magnetic stirring for one week.

II. Characterisation of the Silica Nanoparticles Obtained.

The silica nanoparticles dispersed in water (20 mL) are characterised by analysis using transmission electron microscopy (TEM).

More particularly, these nanoparticles dispersed in water are sampled using carbon film. The carbon film is then dried for a few minutes under a lamp before the nanoparticles are examined.

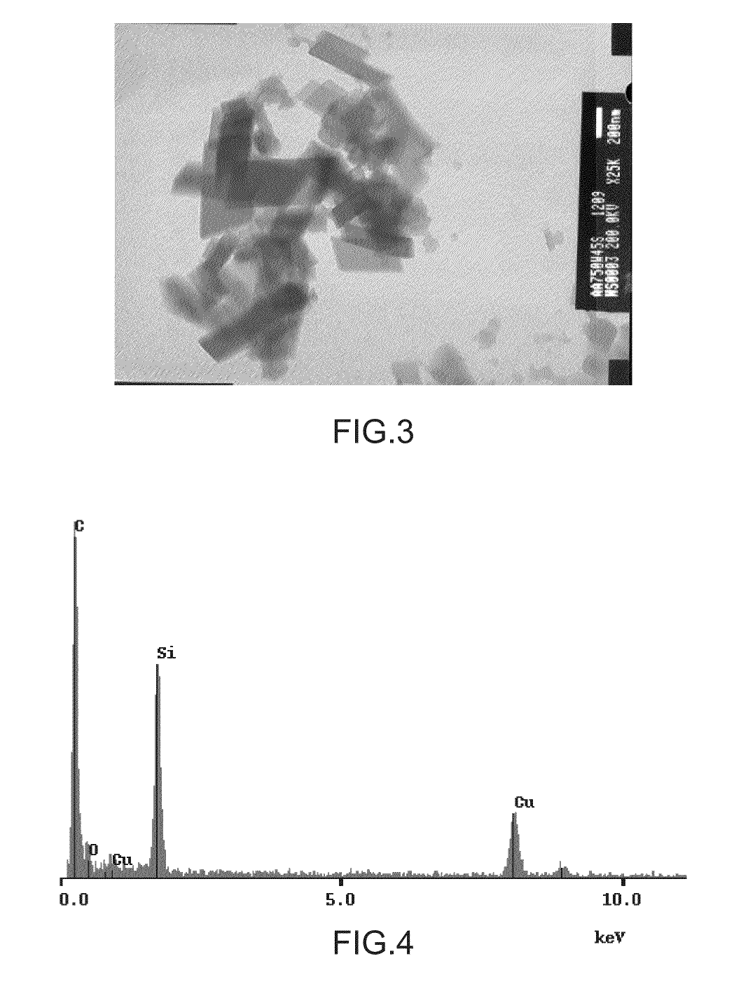

The samples were observed under 2000FX microscopy. Nanoparticles in the form of plates are observed (FIGS. 2 and 3). No difference exists between the nanoparticles obtained according to the 4 irradiation protocols presented above.

In addition the silica nanoparticles containing a phthalocyanine type dye were analysed by EDSX (“Energy Dispersive Spectroscopy of X-rays”) in order to confirm the presence of silica (FIG. 4).

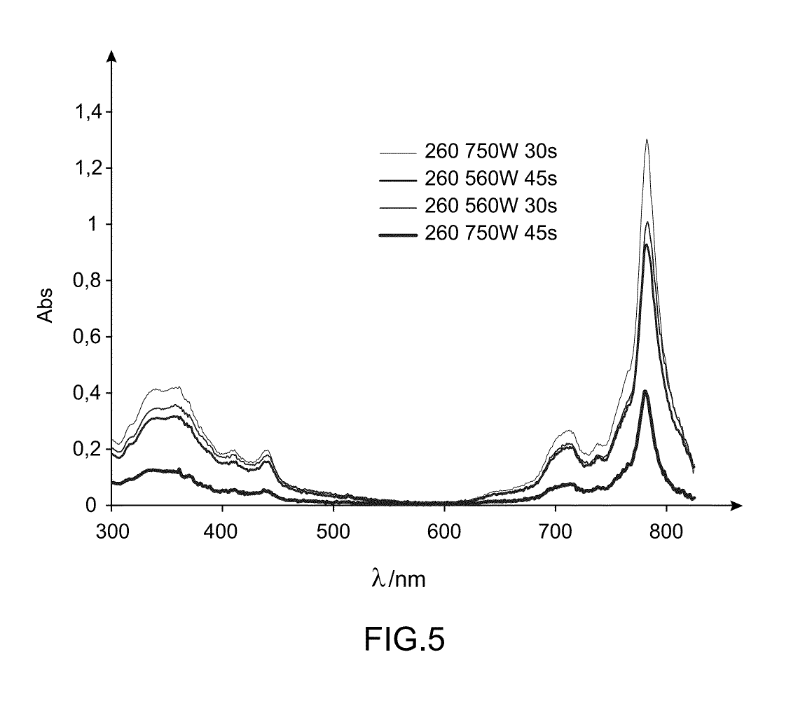

Absorption spectra of the phthalocyanine derivatives in nanoparticles prepared according to the process of the invention generally show two typical absorptions known as Q-band (780-783 nm) and B-band or Soret band (340-360 nm) (FIG. 5). These absorptions are sensitive to molecular substitutions in the phthalocyanine cycle (at peripheral and non-peripheral sites) as well as to the environment in which the phthalocyanine is. It should be noted that, comparatively, the phthalocyanine in silica beads is non-absorbent.

### REFERENCES

[1] U.S. Pat. No. 3,094,536 (Kenney) published on Jun. 18, 1963;
[2] Joyner, R. D.; Cekada, J.; Link Jr. R. G.; Kenney, M. E. J. Inorg. Nucl. Chem. 1960, 15, 387;
[3] Esposito, J. N.; Lloyd, J. E.; Keeney, M. E. Inorg. Chem. 1966, 5, 1979;
[4] Lotfy, R. O.; Hor, A. M.; Rucklidge, A. J. Imag. Sci. 1987, 31, 31;
[5] Belarbi, Z.; Sirlin, C.; Simon, J.; Andre, J. J. Phys. Chem. 1989, 93, 8105;
[6] Hanack, M. Mol. Cryst. Liq. Cryst. 1988, 160, 133;
[7] Castenada, F.; Plichon, V.; Clarisse, C.; Riou, M. T. J. Electroanal. Chem. 1987, 233, 77;
[8] Sims, T. D.; Pemberton, J. E.; Lee, P.; Armstrong, N. R. Chem. Mater. 1989, 1, 26;
[9] International Patent Application WO 2008/083918 (CIBA HOLDING Inc and CIBA SPA) published Jul. 17, 2008;
[10] Hayashida, S.; Hayashi, N. Chem. Mater 1991, 3, 92;
[11] Chen, P.; Tang, D.; Wang, X.; Chen, H.; Liu, M.; Li, J.; Liu, X. Colloids and Surfaces A: Physicochemical and Engineering Aspects 2000, 175, 171;
[12] Nicolau, M.; Henry, C.; Martinez-Diaz, M. V.; Torres, T.; Armand, F.; Palacin, S.; Ruaudel-Teixier, A.; Wegner, G. Synthetic Metals 1999, 102, 1521;
[13] Cammidge, A. N.; Nekelson, F.; Helliwell, M.; Heeney, M. J.; Cook, M. J. J. Am. Chem. Soc. 2005, 127, 16382;
[14] Lee, P. P. S.; Ngai, T.; Wu, C.; Ng, D. K. P. Journal of Polymer Science: Part A: Polymer Chemistry 2005, 43, 837;
[15] Zheng, G.; Chen, J.; Li, H.; Glickson, J. D. PNAS, 2005, 102, 17757;
[16] Patent Application JP2005-272760 (TOYO INK MFG CO) published on Oct. 6, 2005;
[17] Inomata H.; Arai K.; Nakanishi H. Jpn. J. Appl. Phys., 1999, 38, L81;
[18] Dayal, S.; Krolicki, R.; Lou, Y.; Qiu, X.; Berlin, J. C.; Kenney, M. E.; Burda, C. Appl. Phys. B 2006, 84, 309;
[19] Kim, T. H.; Lee, J. K.; Park, W. H.; Lee, T. S. Mol. Cryst. Liq. Cryst. 2006, 444, 23;
[20] International Application WO 2008/138727 (CIBA HOLDING Inc) published on Nov. 20, 2008;
[21] Corradi, A. B.; Bondioli, F.; Ferrari, A. M.; Focher, B.; Leonelli, C. Powder Technol. 2006, 167, 45;
[22] Chau, J. L. H.; Kao, C.-C. J. J. Non-Crystal. Solids 2009, 355, 2448;
[23] Nitschke, C.; O'Flaherty, S. M.; Kröll, M.; Doyle J. J.; Blau, W. J. Chem. Phys. Lett. 2004, 383, 555.

1. Process for preparing a silica particle incorporating at least one phthalocyanine derivative, said particle being prepared from at least one silicone-based derivative of phthalocyanine via a hydrothermal synthesis involving microwaves.

2. A process according to claim 1, wherein said silicone-based derivative of phthalocyanine is a compound with formula (I): 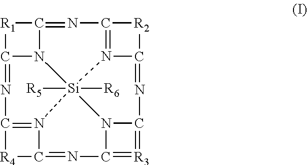
in which:
R₁, R₂, R₃ and R₄, which are identical or different, represent an arylene group, optionally substituted, and
R₅ and R₆, which are identical or different, are selected from the group consisting of —Cl, —F, —OH and OR′ where R′ represents a linear or branched alkyl of from 1 to 12 carbon atoms and notably from 1 to 6 carbon atoms, optionally substituted or a group —Si(R″)₃ where each R″ independently represents a linear, branched or cyclic alkyl of from 1 to 12 carbon atoms and notably from 1 to 6 carbon atoms, optionally substituted.

3. A process according to claim 1, wherein said silicone-based derivative of phthalocyanine is a compound with formula (II): 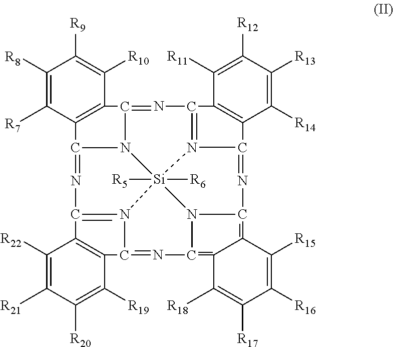
in which:
the groups R₇ to R₂₂, which are identical or different, are chosen from the group consisting of a hydrogen; a carboxylate; an aldehyde; an ester; an ether; a hydroxyl; a halogen; an aryl such as phenyl, benzyl or naphthyl; a linear or branched alkyl of from 1 to 12 carbon atoms and notably from 1 to 6 carbon atoms, optionally substituted, such as methyl, ethyl, propyl or hydroxypropyl; an amine; an amide; a sulphonyl; a sulphoxide and a thiol;
the groups R₅ and R₆, which are identical or different, are selected from the group consisting of —Cl, —F, —OH and OR′ where R′ represents a linear or branched alkyl of from 1 to 12 carbon atoms and notably from 1 to 6 carbon atoms, optionally substituted or a group —Si(R″)₃ where each R″ independently represents a linear, branched or cyclic alkyl of from 1 to 12 carbon atoms and notably from 1 to 6 carbon atoms, optionally substituted.

4. Process according to claim 1, wherein said silicone-based derivative of phthalocyanine is a compound with formula (III) of the naphthalocyanine type: 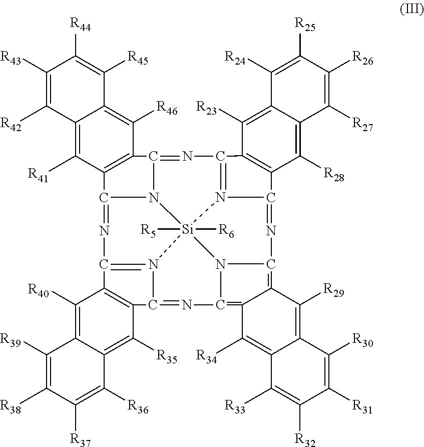
in which:
the groups R₂₃ to R₄₆, which are identical or different, are chosen from the group consisting of a hydrogen; a carboxylate; an aldehyde; an ester; an ether; a hydroxyl; a halogen; an aryl such as phenyl, benzyl or naphthyl; a linear or branched alkyl of from 1 to 12 carbon atoms and notably from 1 to 6 carbon atoms, optionally substituted, such as methyl, ethyl, propyl or hydroxypropyl; an amine; an amide; a sulphonyl; a sulphoxide and a thiol;
the groups R₅ and R₆, which are identical or different, are selected from the group consisting of —Cl, —F, —OH and OR′ where R′ represents a linear or branched alkyl of from 1 to 12 carbon atoms and notably from 1 to 6 carbon atoms, optionally substituted or a group —Si(R″)₃ where each R″ independently represents a linear, branched or cyclic alkyl of from 1 to 12 carbon atoms and notably from 1 to 6 carbon atoms, optionally substituted.

5. Process according to claim 1, wherein said process includes the following successive steps:
a) preparing a first solution (Sₐ) containing at least one silicone-based derivative of phthalocyanine and optionally at least one silane-based compound;
b) mixing the solution (Sₐ) obtained in step (a) with a second aqueous solution (S′) which contains at least one compound allowing hydrolysis of a silane-based compound,
c) exposing the solution (S_{b}) obtained in step (b) to microwave irradiation,
d) recovering the particles of silica incorporating at least one silicone-based derivative of phthalocyanine, obtained during step (c).

6. Process according to claim 5, wherein said solution (Sₐ) is obtained by mixing together at least one silicone-based derivative of phthalocyanine, at least one water-miscible organic solvent and optionally at least one silane-based compound.

7. Process according to claim 6, wherein said water-miscible organic solvent is selected from amongst hydroxylated solvents; liquid glycols of low molecular weight; dimethyl sulphoxide (DMSO); dimethylformamide; dioxane; acetonitrile; acetone; acetic acid; tetrahydrofuran (THF) and mixtures thereof.

8. A process according to claim 6, wherein said water-miscible organic solvent is selected from methanol, ethanol and THF.

9. Process according to claim 5, wherein said silane-based compound(s) has (have) the general formula:
SiRₐR_{b}R_{c}R_{d}
in which Rₐ, R_{b}, R_{c} and R_{d} are, independently of each other, selected from the group consisting of a hydrogen; a halogen; an amine group; a diamine group; an amide group; an acyl group; a vinyl group; a hydroxyl group; an epoxy group; a phosphonate group; a sulphonic acid group; an isocyanate group; a carboxyl group; a thiol (or mercapto) group; a glycidoxy group; an acryloxy group; such as a methacryloxy group; a linear or branched alkyl group, optionally substituted, of 1 to 12 carbon atoms, notably from 1 to 6 carbon atoms; a linear or branched aryl group, optionally substituted, of 4 to 15 carbon atoms, notably 4 to 10 carbon atoms; an alkoxyl group of formula —ORₑ where Rₑ represents a linear or branched alkyl group, optionally substituted, of 1 to 12 carbon atoms, notably from 1 to 6 carbon atoms, and salts thereof.

10. Process according to claim 5, wherein said silane-based compound(s) is(are) selected from the group consisting of dimethylsilane (DMSi), phenyltriethoxysilane (PTES), tetraethoxysilane (TEOS), tetramethoxysilane (TEMOS), n-octyltriethoxysilane, n-octadecyltriethoxysilane, dimethyldimethoxysilane (DMDMOS), (3-mercaptopropyl)trimethoxysilane, (3-mercaptopropyl)triethoxysilane, (mercapto)triethoxysilane, (3-aminopropyl)triethoxysilane, 3-(2-aminoethylamino)propyltrimethoxysilane, 3-[bis(2-hydroxyethyl)amino]propyltriethoxysilane, hexadecyltrimethoxysilane, phenyltrimethoxysilane, N-[3-(trimethoxysilyl)propyl]-1,2-ethanediamine and acetoxyethyltriethoxysilane, 2-hydroxy-4-(3-triethoxysilylpropoxy)diphenylketone, methyltriethoxysilane, vinyltrimethoxysilane, (3-glycidoxypropyl)trimethoxysilane, (benzoyloxypropyl)trimethoxysilane, sodium 3-trihydroxysilylpropylmethylphosphonate, (3-trihydroxysilyl)-1-propanesulphonic acid, (diethylphosphonatoethyl)triethoxysilane, and mixtures thereof.

11. Process according to claim 5, wherein said compound allowing hydrolysis of a silane-based compound is selected from the group consisting of urea, thiourea, ammonia, an amine and mixture thereof.

12. Silica particle containing at least one derivative of phthalocyanine which can be prepared by a process as defined in claim 1, wherein it takes the form of a nanoplate.

13. Silica particle according to claim 12, wherein it occurs in the form of a material which is crystalline and conductive.
